(19) United States
(12) Patent Application Publication
(10) Pub. No.: US 2007/0196581 A1
(43) Pub. Date: Aug. 23, 2007

(54) PROCESS FOR COATING A BIODEGRADABLE ITEM

(76) Inventors: Elizabeth MARCU, Saint Hyacinthe, QC (CA); Eve BELANGER, Saint Hiacynthe, QC (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 11/669,390

(22) Filed: Jan. 31, 2007

Related U.S. Application Data
(60) Provisional application No. 60/763,362, filed on Jan. 31, 2006.

(51) Int. Cl. B05D 3/02; C08J 3/02

(52) U.S. Cl. 427/393; 106/237

(57) ABSTRACT

A process is described for coating a biodegradable item comprising the steps of dissolving from 10-25% ethylcellulose in 75-90% non-aqueous solvent to form a mixture; applying a layer of the mixture onto a surface of the item; and evaporating the solvent to form a coating of from 0.15 g to 0.30 g per 100 cm² on a dry basis. The ethylcellulose may comprise Ethocel™, for example: Ethocel™ 20, Ethocel™ 45 or Ethocel™ 100. The process may be used to form a coating on biodegradable items that require a water barrier, for example cups, trays, or bowls made out of pressed starches, paper, or linted cellulose. Such items may appeal broadly as an environmentally-friendly packaging options.

### CROSS REFERENCE TO RELATED APPLICATIONS

This application claims priority from and derives the full benefit of U.S. Provisional Patent Application 60/763,362 filed Jan. 31, 2006, the entirety of which is herein incorporated by reference.

### FIELD OF THE INVENTION

The present invention relates to a process for coating a biodegradable item, to a biodegradable coating or film, and to objects having a biodegradable coating thereon.

### BACKGROUND OF THE INVENTION

Disposable items such as containers and packaging are often formed of non-biodegradable materials. As environmental awareness increases, consumers and manufacturers are seeking environmentally-friendly technologies and products. There is a demand for biodegradable disposable packaging for use in the packaging of convenience foods. It is desirable to find a replacement for such conventional materials as plastic and blown foams, such as Styrofoam™, which are conventionally used for disposable trays, bowls and cups. In the near future, many jurisdictions may ban packaging materials deemed unfriendly to the environment, or impose a special tax on non-biodegradable products to encourage manufacturers and consumers toward alternative technologies.

Convenience foods that require addition of hot water, such as instant soups or noodles, must be contained in a type of packaging with adequate integrity that is capable of excluding moisture. Trays on which moisture-containing foods are placed and displayed require adequate integrity for shipping and handling. Some convenience foods are packaged in heavy plastic trays with an ability to withstand oven or microwave heating. However, such plastics are not biodegradable. There is a need for convenience food packaging that can exclude moisture, withstand hot temperatures, and biodegrade quickly upon disposal.

### SUMMARY OF THE INVENTION

It is an object of the present invention to obviate or mitigate at least one disadvantage of conventional convenience food packaging, or of previous processes for forming such packaging.

An embodiment of the invention provides a process for coating a biodegradable item comprising the steps of: dissolving 10-25% ethylcellulose in 75-90% non-aqueous solvent, by weight, to form a mixture; applying a layer of the mixture onto a surface of the item; and evaporating the solvent to form a coating of from 0.15 g to 0.30 g per 100 cm² on a dry basis.

Further, an embodiment of the invention provides a biodegradable film-forming composition comprising 10-25% ethylcellulose and 75-90% ethanol.

Additionally, according to the invention, there is provided a process for forming a film comprising the steps of: mixing 10-25% ethylcellulose with 75-90% non-aqueous solvent, by weight, to form a mixture; applying a layer of the mixture onto a surface; and evaporating the solvent to form a film having a weight of from 0.15-0.25 g/100 cm² surface area on a dry basis.

Advantageously, coated items are water-resistant at ambient, refrigerator, and freezer temperatures, and possess a hydrophobic surface. Further, items coated according to the invention possess boiling water resistance for a period of time adequate to allow a hot food or beverage to be consumed. In a humid environment, such a coating as applied according to the invention necessary in order for the item to maintain integrity and desirable properties. These properties are especially advantageous for biodegradable items that, prior to coating, were not able to contain liquids or moisture-containing foods. As a further advantage, items coated according to aspects of the invention will be viewed favorably by the public because of the desirability of using biodegradable disposable packaging. Advantageously, items coated according to the invention may be frozen and heated within the same packaging, whether a microwave oven or a conventional oven is used to apply the heat. Further, the application of the coating to only one portion of the item may be envisioned. In particular, the portion of the item which is to come into contact with the liquid or water-containing food may be coated, while other portions of the item are left uncoated. As further advantages pertinent to embodiments of the invention, the resulting coating or film is odorless, colorless, inert to alkaline, acid and salt solutions.

Other aspects and features of the present invention will become apparent to those ordinarily skilled in the art upon review of the following description of specific embodiments of the invention in conjunction with the accompanying figures.

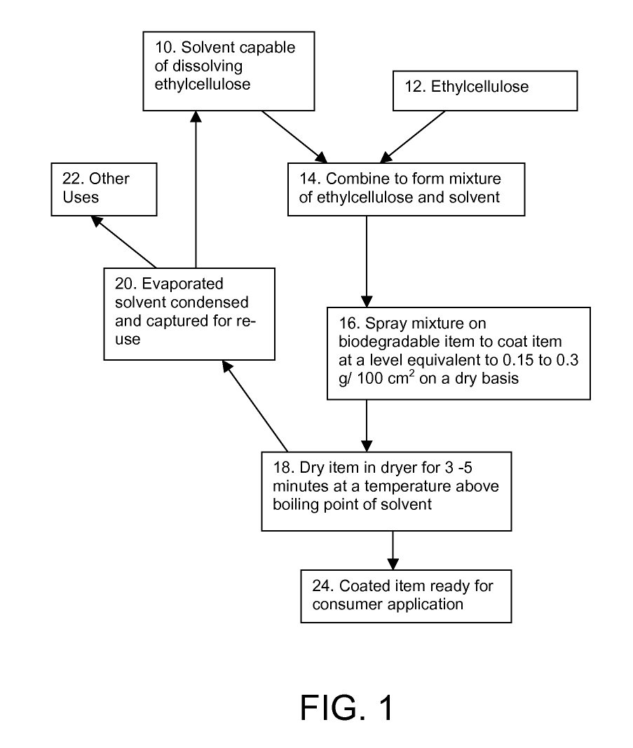

FIG. 1 is a flow chart showing an exemplary process for coating an item according to an embodiment of the invention.

### DETAILED DESCRIPTION

According to an aspect of the invention, there is provided a process for coating a biodegradable item. The process involves dissolving ethylcellulose in a non-aqueous solvent, to form a mixture. The mixture is then applied onto a surface of the biodegradable item. The solvent is then evaporated, leaving a coating on the surface of the item.

As used herein, the term “on a wet basis”, with reference to the mixture, indicates the quantity of the wet mixture while it is still wet, which includes the solvent. The term “on a dry basis”, with reference to the coating formed on an item indicates the quantity present after the solvent has evaporated from the mixture, and thus does not include the solvent.

Quantities of Ethylcellulose. The ethylcellulose is preferably used in a quantity of from 10 to 25% by weight of the mixture. An exemplary range is from 15 to 25% by weight of the mixture. The level of 15% by weight of the mixture is an example of an appropriate amount of ethylcellulose capable of achieving desirable properties of the coating, as described herein.

Types of Ethylcellulose. Various types of ethylcellulose may be used. Ethylcellulose is classified as generally recognized as safe (GRAS) and thus, presents no problem when coating items intended for use in the food industry.

Ethylcellulose can be formed as an organosoluble thermoplastic polymer resulting from the reaction of ethyl chloride with alkali cellulose. Raw materials may include cotton linters and wood pulp. Ethylcellulose resins are conventionally used in such exemplary applications as industrial coatings and pharmaceuticals, for example in forming controlled release dosage formulations, or as granulation binders. For those grades of ethylcellulose leading to more viscous mixtures, heating of the mixture may be employed in order to achieve a less viscous mixture capable of being coated onto an item with the desired distribution density per unit area.

Commercially available brand-name sources of ethylcellulose may be used, for example, the product ETHOCEL™, available from The Dow Chemical Company. Various grades of ETHOCEL™ ethylcellulose resins are available, for example ETHOCEL grades 20, 45, or 100 may be used. ETHOCEL™ meets the requirements of numerous FDA regulations for food applications.

The Non-Aqueous Solvent. The non-aqueous solvent that can be used with the invention may be any solvent in which ethylcellulose is soluble, and which is appropriate for the desired application. Many organic solvents can be used. In an instance where the item to be coated will come into contact directly with food, it would be desirable to use ethanol, which is an FDA approved solvent. Other solvents capable of dissolving ethylcellulose include other alcohols, such as isopropyl alcohol, or non-polar solvents such as toluene. Mixtures of solvents may be used. Examples of solvents and solvent mixtures that may be used with the invention (provided on a % volume/% volume basis are: 20 methylene chloride/80 ethanol; 50 methylene chloride/50 ethanol; 80 methylene chloride/20 ethanol; ethanol; 70 acetone/30 n-propanol; 65 acetone/35 n-propanol; 50 acetone/50 n-propanol; 85 methyl acetate/15 methanol; 80 methyl acetate/20-propanol; 65 methyl acetate/35 DOWANOL PM glycol ether; 70 methyl isobutyl ketone/30 methanol; and 65 methyl isobuthyl ketone/35 methanol. Of course, other solvent ratios may be used provided these solvents are adequate to dissolve ethylcellulose.

As described below, it is not necessary that water be excluded from the mixture, but given the low solubility of ethylcellulose in water, the quantity of non-aqueous solvent must be adequate to ensure the ethylcellulose becomes dissolved. The non-aqueous solvent may be used in an amount of from 70 to 95% (by weight) of the resulting mixture. Within this range, the level selected depends on the quantity of ethylcellulose used, and on the amount of water or other additives included (if any). Selection of the level of non-aqueous solvent used will also impact physical properties of the resulting mixture, such as viscosity.

Evaporation of Solvent. In the process of the invention, the removal of solvent by evaporation is generally conducted by heating to a temperature above the boiling point of the solvent. For example, the boiling point of ethanol is 78.5° C., and an appropriate temperature at which ethanol can be evaporated from the mixture is at 90° C. When this temperature is applied for 3 to 5 minutes, the ethanol solvent evaporates from the mixture. As a result, the coating shrinks and adheres to the object, becoming tight on the surface. By selecting a temperature for evaporation that is 10 to 15° C. higher than the boiling point of the solvent, drying time can be optimized. Other methods of evaporating the solvent may also be employed. For example, mild vacuum may be applied, or air currents adjacent to the surface of the coated item may be imposed during the evaporation process. The item is heated in an oven which may optionally be fitted with seals and a region appropriate for collection of solvent fumes. The solvent fumes, once collected, may be condensed and re-used, as described below.

Recovering and Re-using Solvent. The instant invention has a number of environmental advantages, relating to the biodegradability of the coating. However, as a further, optional, environmental advantage of the inventive process, the solvent used may be recovered by collecting the solvent as it evaporates during the drying process. The solvent can essentially be recovered in a highly pure form, and can then be reused in the process when dissolving a further batch of ethylcellulose into the solvent. For example, if the coated item is sent to a dryer to evaporate the solvent, the dryer may be an oven that is enclosed and may have a fluid circulation or a pressure differential that encourages solvent vapors toward a recovery zone. A sealed oven or dryer may be one that is exhausted to a condensation zone, appropriate for condensation of the solvent removed. Upon recovery and condensation of the solvent back to a liquid form, that may be re-used in the process, or recycled for different, unrelated applications.

Such a condensation zone could be a water cooled condenser, such as a shell and tube heat exchanger in which one fluid runs through one or more finned tubes, while the other fluid runs over the tubes in order to be cooled. Alternatively a tube and tube heat exchanger may be used. Ethanol fumes can be made to circulate in contra-current with cold water to allow the condensate to revert to liquid phase. Any type of condensation process acceptable to those of skill in the art could be employed in the condensation zone within the recovery zone.

FIG. 1 provides a general process scheme of an embodiment of the invention that incorporates evaporation, condensation, and re-use of solvent. Briefly, a solvent (10) capable of dissolving ethylcellulose is mixed together with ethylcellulose (12) to form a mixture (14). The mixture is sprayed (16) onto a biodegradable item, such as a starch-based tray, in an amount that (once dried) will result in additional weight of 0.15 to 0.3 g/100 cm² on a dry basis. The item is then dried (18) using a dryer, such as an oven, for 3 to 5 minutes at a temperature above the boiling point of the solvent. Solvent evaporated during the drying process is condensed and captured for re-use (20), and can be returned to and mixed with fresh solvent for preparing the mixture with ethylcellulose, or can simply be recycled for other uses (22). The dried item is then ready for use in any appropriate consumer application.

Use of Water in the Mixture. As an additional component of the mixture, water may be added. However, the resulting mixture would still fall within the range of from 10-25% ethylcellulose and 75-90% non-aqueous solvent. It is possible to include water in the mixture at a level of up to about 10%. By adding water, the mixture may be formulated to achieve the desired viscosity for effective spraying or coating of an item, while reducing the cost of the solvent. The addition of water may impact upon the properties of the mixture. For example, the viscosity or drying temperature of the mixture may be impacted by addition of water. The drying temperature is set to allow for the solvent to evaporate from the mixture once it is coated on a surface. If the non-aqueous solvent has a boiling point lower than that of water, it may be required to increase the drying temperature or time to ensure that all water has been evaporated from the coating once sprayed.

Additional Non-Solvent Components. When preparing the mixture for use with the invention, addition of optional non-solvent components may be desirable to achieve certain properties, including alteration of color or texture. Components such as those known to people skilled in the art may include plasticizers, waxes, oils, coloring agents, or a combination of these. Preferably, if such additives are included, these too should be biodegradable so as to appeal broadly to the target market of consumers and manufacturers concerned with the environment. Additives that are not biodegradable would still work with the invention, and can be used in quantities that would not significantly reduce the overall biodegradability of the coated item. It is desirable to add any additional non-solvent components at a level of no more than 10% by weight of the mixture, bearing in mind the resulting mixture would still fall within the range of from 10-25% ethylcellulose and 75-90% non-aqueous solvent.

Thickness of the Coating. The mixture may be coated onto an item in an amount of from 1 to 3 g/100 cm² on a wet basis. For example, a surface area of 240 cm² may be coated with 3 g of mixture, translating into an amount of 1.25 g/100 cm² on a wet basis. Once the solvent is evaporated, the remaining weight of the coating upon the item would correspond to the weight of the ingredients other than solvent that were contained in 3 g of mixture. In the instance where the applied 3 g of mixture contains 15% ethylcellulose and 85% solvent, the dry coating results in 0.45 g of additional weight per 240 cm² of surface area of the item. Thicker or thinner coatings may be used depending on the desired application, and cost considerations. Once dried on the item (after solvent evaporation) an exemplary coating would contribute from 0.15 to 0.3 g per 100 cm² of coated surface area of the object, with a preferable range being from 0.15 to 0.25 g per 100 cm² on a dry basis.

The Item to Be Coated. The advantageous biodegradable properties of the mixture make the coating most applicable to biodegradable items that require a water barrier thereon. The item itself would not need to be biodegradable in order to function with the coating applied thereto, but biodegradable items so coated would appeal broadly to the target market of consumers and manufacturers searching for environmentally-friendly packaging options. Examples of materials from which the biodegradable item may be formed include starch or cellulose. Paper, linted cellulosic products, or pressed starches from such plants as rice, wheat or corn may be used.

The item to be coated may be a cup, a tray or a bowl. Dehydrated instant soup noodles are often provided in Styrofoam™ containers, so as to allow adequate integrity and insulation when containing from 250 to 500 mL of hot liquid, as well as to ensure water resistance. An item not previously capable of containing a hot liquid, such as a starch-based formulation, can be coated according the invention to achieve an item with adequate boiling water resistance to support and contain hot soup. Trays for frozen microwavable entrees are often formed of plastic so as to ensure adequate integrity when either frozen or when exposed to microwave energy. A starch-based tray formed with a coating thereon in accordance with the invention would be capable of containing a frozen entree, despite exposure to moisture within a freezer environment. Additionally, when such an item is destined for microwave thawing and heating, the item will have adequate hot water resistance. Coated items may also be formed of materials capable of use in a conventional oven. The coating formed thereon according to the invention also provides heat-resistance in a conventional oven so that the tray is adequately heat-resistant for this application.

According to the invention, it is not required to coat the entire object, but it may only be necessary to coat the portion of the object intended to come into contact with liquid or food. In this way, the cost of the process can be optimized because the mixture can be applied in a unidirectional manner (for example, an item need only be sprayed on one side), and the quantity of mixture used can be minimized.

A Film-Forming Composition. According to a further aspect of the invention, a biodegradable film forming composition comprising 10-25% ethylcellulose and 75-90% ethanol is disclosed. Preferably, the film-forming composition comprises from 15% -25% ethylcellulose and 75-85% ethanol, and more preferably, the level of 15% ethylcellulose can be selected. The composition may contain water or any of the non-solvent additional components described herein

Formation of a Film. According to a further aspect of the invention, the film-forming composition may be used to form a film that is not formed on or integrally connected to a biodegradable item. The film itself may be formed as a stand-alone product in a thin layer, so as to act as a moisture-excluding wrap as an alternative to conventionally applied plastic wraps. In order to form such a film, the film-forming composition may be sprayed onto a surface from which it can easily be removed once dried, or may be extruded and dried in rapid succession. The film so formed may be cut into a size adequate for the desired use, or may be rolled so as to be accessible for later use through un-rolling. When forming such a film, 10-25% ethylcellulose is dissolved in 75-90% non-aqueous solvent (by weight) to form a mixture. A layer of the mixture may be, for example, applied to a surface and the solvent is subsequently evaporated.

According to another aspect of the invention, a biodegradable item is disclosed comprising a biodegradable core coated with a water-resistant film of ethylcellulose. The water-resistant film can be present in an amount of from 0.15-0.30 g/100 cm² once dried. An exemplary range is from 0.15-0.25 g/100 cm², once dried.

### EXAMPLE 1

Coating a Starch-Based Tray for Freezing and Re-Heating Lasagna

Starch-based square trays having dimensions of about 20 cm ×15 cm×6 cm are obtained from Biosphere Industries (Carpinteria, Calif.).

A mixture of Ethocel™ 45 is prepared in ethanol by combining 15% Ethocel™ 45 in ethanol on a weight/weight basis. The mixture is sprayed onto the trays as a thin and uniform layer so that, on a wet weight basis, 240 cm² of surface area is coated with 3 g of mixture (on a wet basis), which is the equivalent of about 1.25 g/100 cm². The trays so coated are dried quickly in a 90° C. radiant heat oven for 3 minutes. On a dry basis, the coating contributes about 0.45 g per 240 cm² area (0.1875 g/100 cm²). The oven is sealed so as to capture evaporated ethanol fumes from the drying process. Ethanol fumes are then condensed and re-used for subsequent processing steps. Trays are removed from the oven.

Once the trays are cooled to room temperature, the lasagna product to be heated is placed in the tray.

Commercially available frozen lasagna intended for a small family meal, having approximately four servings, is placed into the tray so coated. The tray containing the lasagna is frozen. Sample trays are heated either by microwave oven for approximately 20 minutes, or by heating in a conventional oven, according to the instructions provided with the lasagna, in a 190° C. oven.

Both the microwave oven and conventional oven heated lasagna are properly heated. The coated tray is able to be removed from the oven while maintaining its structural integrity. The lasagna so heated does not stick to or soak through the coated tray.

### EXAMPLE 2

Disposable Soup Bowl

Starch-based bowls having a diameter of about 10 cm are obtained from Biosphere Industries (Carpinteria, Calif.). The bowls are intended for individual-sized servings of an instant reconstitutable convenience food, such as soup or noodles.

A mixture of Ethocel™ 20 is prepared in ethanol by combining 20% Ethocel™ 20 in ethanol on a weight/weight basis. The mixture is sprayed onto the interior surface of the bowls as a thin and uniform layer so that, on a wet weight basis, 360 cm² of surface area is coated with 4 g of mixture (on a wet basis), which is the equivalent of about 1.1 g/100 cm². The bowls so coated are dried quickly in a 90° C. radiant heat oven for 4 minutes. The oven is sealed so as to capture evaporated ethanol fumes from the drying process. Ethanol fumes are then condensed and re-used for subsequent processing steps. Bowls are removed from the oven. On a dry basis, the coating contributes about 0.8 g per 360 cm² area (0.22 g/100 cm²).

Once the bowls are cooled to room temperature, boiling water is placed in the bowl. Bowls containing water within about 1 cm of the upper rim are allowed to sit for approximately 1 hour. Bowls do not exhibit leakage during the 1 hour time period, and can be picked up and handled while containing the hot water. Bowls maintained structural integrity over the 1 hour period.

### EXAMPLE 3

Biodegradability of Coated versus Uncoated Starch-Based Item

Starch-based trays either uncoated or coated as described in Example 1, was tested for biodegradability using test method OECD 301 C (Modified MITI Test) from the Organization of Economic Cooperation and Development.

Methods

Chemical oxygen demand (COD) of both the coated and uncoated trays was determined in order to determine the maximum quantity of oxygen that could be required by microorganisms to oxidize the organic matter contained within the trays. The COD is determined using an aqueous suspension of the trays according to Standard Methods for the Examination of Water and Wastewater 5220 C (closed reflux). The organic matter is oxidized when the sample is refluxed in a strongly acidic solution with a known excess of potassium dichromate (K₂Cr₂O₇). After digestion, the remaining unreduced potassium dichromate is titrated with ferrous ammonium sulfate to determine the amount consumed. Thus, the oxidizable organic matter is calculated in terms of oxygen equivalent. A 1/100 suspension of each item was made for determining COD.

Biodegradabity of the trays was estimated by measuring the oxygen uptake of microorganisms in contact with a sample during a period of 28 days. The items are suspended in container containing a mineral medium seeded with activated sludge inoculum from a wastewater treatment plant. A nitrifying inhibitor (2-chloro-6-(trichloromethyl)pyridine) is added to each container in order to inhibit the nitrifying bacteria activity present in the activated sludge. To validate the test, a reference compound known to be biodegradable is tested simultaneously. A blank control (mineral medium only) is also evaluated in order to determine the oxygen uptake caused by the inoculum itself. Abiotic degradation, when present, is determined by substituting the inoculum for a toxic product (mercuric chloride). On the basis of the measured Biological Oxygen Demand (BOD), biodegradability can be calculated as:

$$\begin{matrix}\% degradation = \frac{BOD of sample - BOD of blank}{Concentration of item ( mg {O}_{2} \text{/} liter )} & ( I ) \\ \% biodegradation = \% degradation - \% abiotic loss & ( II )\end{matrix}$$

For the tests conducted, the reference compound used was sodium benzoate, at a concentration of 100 mg O₂/liter. The product to be tested was a starch-based tray either uncoated or coated according to the invention with a mixture of 15% ETHOCEL 45 with 85% ethanol, after the ethanol solvent was evaporated. The process for forming the coated tray is described in Example 1. The products to be tested were also prepared at a concentration having a chemical oxygen demand of 100 mg O₂/liter. The inoculum used was activated sludge from wastewater treatment facilities located in Valcartier, Quebec. The inoculum rate was 6 ml/liter, and the incubation temperature was 25±1° C. A Hach model 2173B respirometer was used for measurements. BOD readings were taken every seven days for a 28 day period.

Results

The Chemical Oxygen Demand (COD) for the uncoated starch tray was 897 mg O₂/g, while the COD for the uncoated starch tray was 878 mg O₂/g.

According to OECD 301 C test methodology, a test product is considered “readily biodegradable” if it is decomposed at a level of 60% or more within the 28 day test period. It was found that the coated tray can be considered “readily biodegradable” because it was 73% degradable within the 28 day test period.

The above-described embodiments of the present invention are intended to be examples only. Alterations, modifications and variations may be effected to the particular embodiments by those of skill in the art without departing from the scope of the invention, which is defined solely by the claims appended hereto. All documents referred to herein are incorporated by reference in their entirety.

1. A process for coating a biodegradable item comprising the steps of:
dissolving 10-25% ethylcellulose in 75-90% non-aqueous solvent, by weight, to form a mixture;
applying a layer of the mixture onto a surface of the item; and
evaporating the solvent to form a coating of from 0.15 g to 0.30 g per 100 cm² on a dry basis.

2. The process of claim 1 wherein 15-25% ethylcellulose is used to form the mixture.

3. The process of claim 1 wherein the non-aqueous solvent is ethanol.

4. The process of claim 1 wherein the layer of mixture is applied in an amount of from 1 to 3 g/100 cm² on a wet basis.

5. The process of claim 4 wherein after evaporating the solvent, the weight contributed by the coating is from 0.15 g to 0.25 g per 100 cm² on a dry basis.

6. The process of claim 1 wherein the step of evaporating the non-aqueous solvent comprises heating to a temperature above the boiling point of the solvent.

7. The process of claim 1 additionally comprising the step of recovering the non-aqueous solvent after evaporation.

8. The process of claim 1 wherein about 15% ethylcellulose is mixed with ethanol as the non-aqueous solvent.

9. The process of claim 1 wherein the ethylcellulose comprises Ethocel™.

10. The process of claim 9 wherein the ethylcellulose comprises Ethocel™ 20, Ethocel™ 45 or Ethocel™ 100.

11. The process of claim 1 wherein the step of mixing includes addition of a plasticizer, a wax, an oil, a coloring agent, water, or a combination of these to the mixture.

12. The process of claim 1 wherein the step of mixing includes addition of up to 10% water to the mixture.

13. The process of claim 1 wherein the mixture consists of 15% Ethocel™ and 85% ethanol.

14. The process of claim 1 wherein the biodegradable item is formed of starch, paper, or cellulose.

15. The process of claim 1 wherein the biodegradable item is a cup, a tray or a bowl.

16. A biodegradable film-forming composition comprising 10-25% ethylcellulose and 75-90% ethanol.

17. The biodegradable film-forming composition of claim 16 comprising 15% -25% ethylcellulose and 75-85% ethanol.

18. The biodegradable film-forming composition of claim 15 consisting of 15% ethylcellulose and 85% ethanol.

19. The biodegradable film-forming composition of claim 17 wherein ethylcellulose comprises Ethocel™.

20. A process for forming a film comprising the steps of:
mixing 10-25% ethylcellulose with 75-90% non-aqueous solvent, by weight, to form a mixture;
applying a layer of the mixture onto a surface; and
evaporating the solvent to form a film having a weight of from 0.15-0.25 g/100 cm² surface area on a dry basis.
